(19) United States
(12) Patent Application Publication
(10) Pub. No.: US 2004/0078484 A1
(43) Pub. Date: Apr. 22, 2004

(54) Systems and methods for updating viewable content

(76) Inventors: Travis J. Parry, Boise, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/273,581

(22) Filed: Oct. 18, 2002

(51) Int. Cl. G06F 15/173

(52) U.S. Cl. 709/242

(57) ABSTRACT

The present disclosure relates to systems and methods for updating viewable content. In one embodiment, a system and method pertain to reading a network address from a video storage medium using a video playing device, accessing a content source via a network with the video playing device using the network address, downloading video content from the content source, and providing the downloaded video content to a viewer.

### FIELD OF THE DISCLOSURE

The present disclosure relates to updating viewable content. More particularly, the disclosure relates to systems and methods with which the content stored on a video storage medium can be supplemented with or replaced by new content.

### BACKGROUND

Many different types of viewable features or events stored on video storage media are available for purchase or rental. For example, movies, concerts, and television shows recorded on video tapes and digital video discs (DVDs) may be purchased or rented from movie rental stores, electronics stores, and so forth.

Often times, additional content is stored on the video storage medium beyond the recorded feature. For instance, in the case of movies, trailers for upcoming movies and advertisements for various products may be stored on the video storage medium for the viewer to watch before the movie. While this content may be current where the storage medium was watched soon after its distribution, this content may be out-of-date if the medium is watched at a later time. To cite an example, if a movie trailer is stored on the medium that states that the advertised movie is “coming to a theater near you this fall,” the trailer may be out-of-date, and therefore useless, if the video storage medium on which the purchased movie is stored was rented several months (or years) after the medium was placed on the shelf for renting. In that the content on the storage medium is static, a similar result occurs where the movie is purchased and watched soon after being placed on sale, but watched again at some later date, e.g., a year later.

Providing out-of-date content to the viewer is undesirable for several reasons. First, the content may provide incorrect information to the viewer, as in the examples identified above. In addition, the video storage medium distributor misses an opportunity to generate revenue that could be made for presenting up-to-date content for the viewer to watch each time the recorded feature (e.g., movie) is watched. Furthermore, the viewer may be annoyed by the static, out-of-date content, particularly in situations in which the viewer watches the recorded feature repeatedly, for example in the case of a “favorite” movie.

From the above, it can be appreciated that it would be desirable to be able to present up-to-date content to the viewer each time a viewer watches a feature stored on a video storage medium.

### SUMMARY OF THE INVENTION

The present disclosure relates to systems and methods for updating viewable content. In one embodiment, a system and a method pertain to reading a network address from a video storage medium using a video playing device, accessing a content source via a network with the video playing device using the network address, downloading video content from the content source, and providing the downloaded video content to a viewer.

### BRIEF DESCRIPTION OF THE DRAWINGS

The components in the following drawings are not necessarily to scale.

FIG. 1 is a schematic view of an example system through which updated content can be provided to a viewer.

FIG. 2 is a block diagram of an embodiment of a video playing device shown in FIG. 1.

FIG. 3 is a block diagram of an embodiment of a content source shown in FIG. 1.

FIG. 4 is a flow diagram that illustrates an example of use of the system of FIG. 1 in providing updated content to a viewer.

FIGS. 5A and 5B provide a flow diagram that illustrates an example of operation of a content manager of the video playing device of FIG. 2.

FIG. 6 is a flow diagram that illustrates an example of operation of a content download manager of the content source of FIG. 3.

### DETAILED DESCRIPTION

Disclosed herein are systems and methods through which updated content can be provided to a viewer of a feature or event stored on a video storage medium. Examples of such features include movies, concerts, artistic performances, television shows, video games, and other such features or events that are sold and/or rented to the consuming public. With the disclosed systems and methods, the new content can be downloaded to the viewer's video playing device, and then presented to the viewer to watch. To facilitate description of the manner in which such content is provided, example systems are first discussed with reference to the figures. Although these systems are described in detail, these systems are provided for purposes of illustration only and various modifications are feasible. After the example systems have been described, examples of operation of the systems are provided to explain the manners in which content updating can be facilitated.

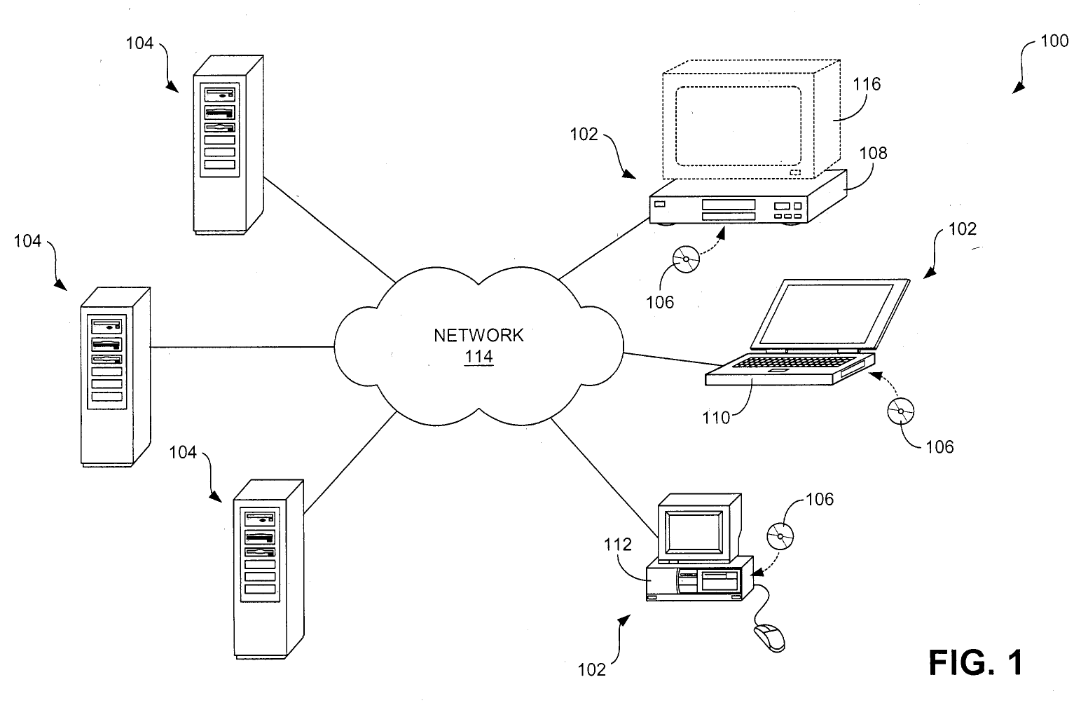

Referring now in more detail to FIG. 1, illustrated is an example system 100 with which a updated video content can be provided to a viewer. As indicated in this figure, the system 100 generally comprises one or more video playing devices 102 and one or more content sources 104. The video playing devices 102 are adapted to play, and potentially write to, video storage media 106. For purposes of discussion, the video storage media 106 are assumed to comprise digital video discs (DVDs) purchased or rented by the viewer. Although DVDs are illustrated in FIG. 1 and explicitly identified herein, the video storage media 106 can comprise other storage media that can be used to initiate or otherwise facilitate download of video content. Accordingly, in some embodiments, the video storage media 106 can, alternatively, comprise read/write compact discs (CDRWs), video compact discs (VCDs), video tapes, floppy discs, solid-state storage media, game cartridges, or the like.

In the DVD context, the video playing devices 102 can, for instance, comprise one of a DVD player 108 (which is adapted to display video on an appropriate viewing device such as a television 116), a notebook computer or portable DVD player 110, or a desktop computer 112. Alternative video playing devices 102 may be implicated depending upon the particular nature of the video storage medium 106. For example, a video playing device 102 can comprise a video projector. In another example, where the storage medium comprises a game cartridge, the playing device 102 may comprise a game console. Irrespective of the particular nature of the video playing device 102 used, the device is connected (either through a wired or wireless connection) to a network 114 to which the content sources 104 are also connected. The network 114 typically comprises one or more sub-networks that are communicatively coupled to each other. By way of example, these networks can include one or more local area networks (LANs) and/or wide area networks (WANs). In some embodiments, the network 114 may comprise a set of networks that forms part of the Internet.

The content sources 104 typically comprise a computing device having memory on which video content available for download is stored. By way of example, the content sources 104 comprise one or more servers that are accessible over the World Wide Web (WWW). In an alternative embodiment, the content source can simply comprise a separate storage medium (e.g., CD or DVD) that is used to upload content to the video playing device 102 and, optionally, download the content to the original storage medium 106.

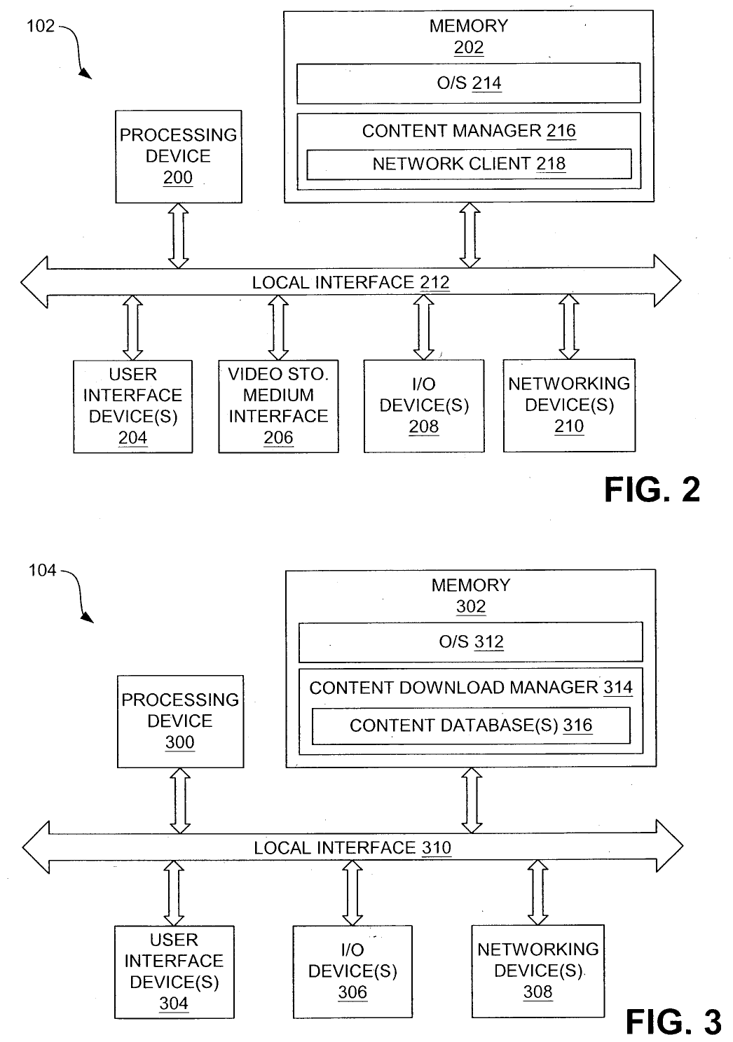

FIG. 2 is a block diagram illustrating an example architecture for the video playing devices 102 shown in FIG. 1. As indicated in FIG. 2, each video playing device 102 can comprise a processing device 200, memory 202, one or more user interface devices 204, one or more storage medium interface devices 206, one or more I/O devices 208, and one or more networking devices 210, each of which is connected to a local interface 212. The processing device 200 can include any general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the video playing device 102. The memory 202 can include any one of a combination of volatile memory elements (e.g., random access memory (RAM) and nonvolatile memory elements (e.g., hard drive, compact disc read only memory (CDROM), etc.).

The one or more user interface devices 204 comprise those components with which the user can interact with the video playing device 102. Where the video playing device 102 comprises a DVD player (such as player 108), these components can comprise one or more buttons provided on a control panel of the player. Additionally, the user interface devices 204 may include the hardware necessary to receive commands input using a remote control device (e.g., infrared (IR) remote controller), such as a wireless receiver. Where the video playing device 102 comprises a computing device, such as a notebook or desktop computer, the user interface devices 204 can comprise a keyboard and mouse.

The user interface devices 204 normally further include a display such as a liquid crystal display (LCD) provided on a control panel of a DVD player, or a monitor of a notebook or desktop computer. Where the video playing device 102 comprises a DVD player or similar device intended for use with a television, the television itself may be thought of as comprising the display (e.g., in on-screen player control schemes).

The storage medium interface devices 206 comprise the components used to read and, in some embodiments, write to the video storage medium 106 for which the playing device 102 is adapted. In addition, these interface devices 206 may include a separate reading device that is configured to collect information as to the feature stored on the video storage medium or an identification code associated with the storage medium itself. As described below, this separate device may comprise a scanner or other device that is used to read a code provided on the exterior of the video storage medium 106.

The one or more I/O devices 208 comprise components used to facilitate connection of the video playing device 102 to other devices such as, for example, a television. Therefore, these devices can, for instance, comprise one or more video and audio output ports, and/or serial, parallel, small system interface (SCSI), universal serial bus (USB), or IEEE 1394 (e.g., Firewire™) connection devices. The networking devices 210 comprise the various components used to transmit and/or receive data over the network 114. By way of example, the networking devices 210 include a device that can communicate both inputs and outputs, for instance, a modulator/demodulator (e.g., modem), a radio frequency (RF) or IR transceiver, a network card, etc.

The memory 202 normally comprises various programs (in software and/or firmware) including an operating system (O/S) 214 and a content manager 216. The O/S 214 controls the execution of other programs and provides scheduling, input-output control, file and data management, memory management, and communication control and related services. The content manager 216 is used to facilitate the retrieval of video content and to manipulate the content once retrieved. As indicated in FIG. 2, the content manager 216 comprises, or may access, an embedded network client 218 that is used to access the content sources 104 for the purpose of initiating or otherwise facilitating the download of content to the video playing device 102 via the network 114. Examples of operation of the content manager 216 are provided below.

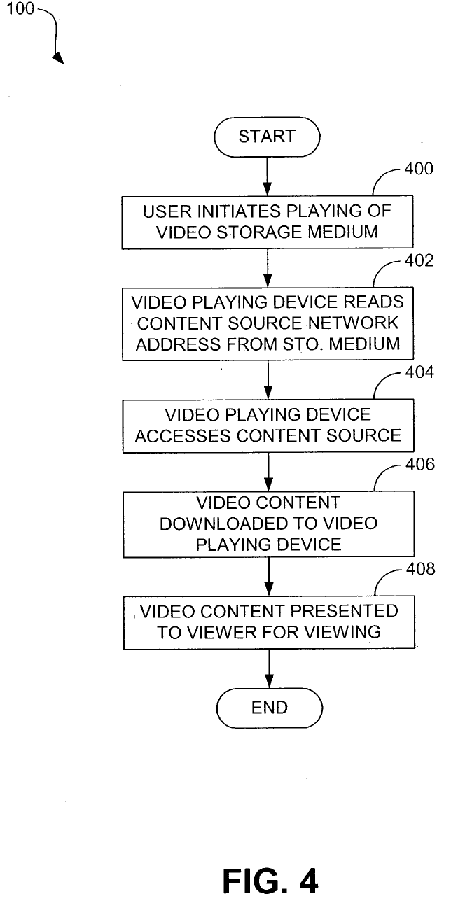

FIG. 3 is a block diagram illustrating an example architecture for the content sources 104 shown in FIG. 1. As indicated in FIG. 3, each content source 104 can comprise a processing device 300, memory 302, user interface devices 304, I/0 devices 306, and one or more networking devices 308. Each of these components is connected to a local interface 310 that, by way of example, comprises one or more internal buses. The processing device 300 is adapted to execute commands stored in memory 302 and can comprise any custom made or commercially available processor, a central processing unit (CPU) or an auxiliary processor among several processors associated with the video playing device 102, a semiconductor based microprocessor (in the form of a microchip), or a macroprocessor. The memory 302, can comprise substantially any volatile or non-volatile memory, or combination thereof.

The user interface devices 304 typically comprise those components typically used with computing devices, such as a keyboard and a mouse. The I/O devices 306 and networking devices 308 can have configurations similar to like-named components identified above with reference to FIG. 2. The memory 302 includes an operating system 312 and a content download manager 314 that comprises a program that facilitates download of video content to viewers. As indicated in FIG. 2, the manager 314 can include, or access, one or more content databases 316. Examples of operation of the content download manager 314 are provided in the discussions below.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The disclosed programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussion that follows, flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

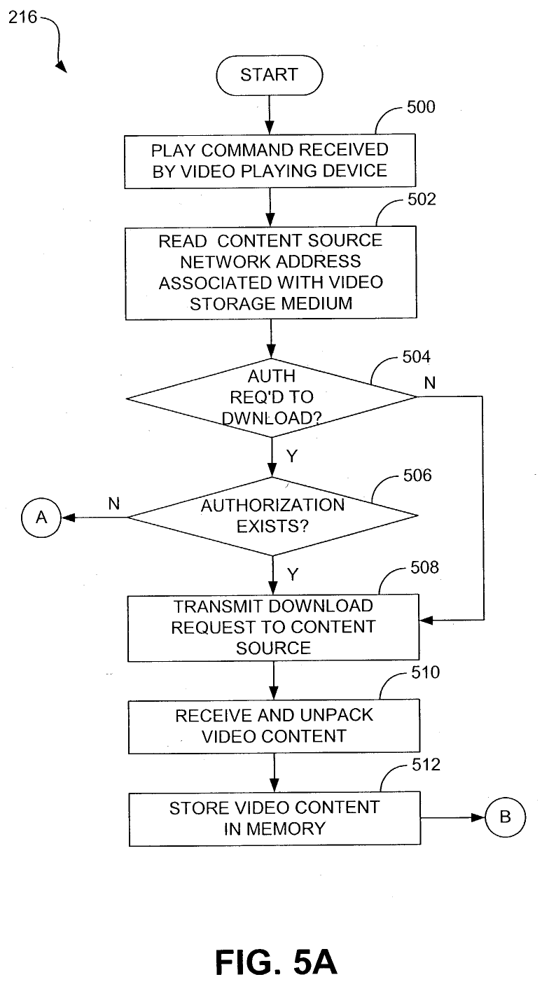

As noted above, the system 100 can be used to provide up-to-date video content for viewing using a video playing device 102. A high-level example of the operation of the system 100 in providing such content is illustrated in FIG. 4. Beginning with block 400 of this figure, the user initiates playing of the video storage medium 106. For instance, where the video storage medium comprises a DVD, the user places the DVD in the drive of a DVD player and selects a “play” command (or playing automatically occurs upon insertion of the DVD). Once playing is initiated, the video playing device 102 reads a content source network address from the video storage medium 106, as indicated in block 402. As used herein, the term “network address” is a general term used to identify substantially any address that may be used to access a content source 104 and, therefore, facilitate the obtaining of content. By way of example, the network address can comprise a universal resource locator (URL), a file transfer protocol (FTP) directory, a hypertext transfer protocol (HTTP) directory, email address, or the like. Where the storage medium comprises a DVD or other digitally readable storage medium (e.g., floppy disc, game cartridge, etc.), this address may be stored on the storage medium and read by the video playing device 102, for instance with a reading head of the device. In embodiments in which the video storage medium 106 is not digitally readable, for example where the medium comprises a conventional video (e.g., VHS) tape, this information may be stored in an appropriate code (e.g., bar code or two dimensional code) provided on the exterior of the medium (e.g., tape housing) that may be read with an appropriate reading device of the storage medium interface devices 206 (e.g., scanner).

Once the content source network address has been obtained, irrespective of the manner in which it is obtained, the video playing device 102, assuming it has appropriate authorization from the viewer, accesses the content source 104, as indicated in block 404. This access is facilitated with the embedded network client 218. After the video playing device 102 accesses the content source 104, video content can then be downloaded to the video playing device, as indicated in block 406. This content can comprise substantially any content that can be played by the video playing device 102, and therefore viewed by the viewer. By way of example, the video content may comprise advertising materials including product/service commercials, movie trailers, promotional offers, contests, etc.; additional content that can be added to the main feature stored on the video storage medium 106 (e.g., new and/or re-mastered movie scenes or game sequences, G-rated scenes replace more adult-themed movie scenes, product content that replaces the original product content shown in a movie (to replace one brand soft drink with another), etc.); subtitles; and so forth. In game context, the content can further comprise RAM patches, game updates, bug fixes, etc. that will modify game play.

Notably, the content that is not specifically relevant to the feature stored on the video storage device 106 may be content that is intended for the audience believed to be most likely to watch and/or purchase the video storage device. For example, where the video storage device 106 stores an action movie, the downloaded video content may comprise commercials advertising products believed to appeal most to men and/or the action film genre. Once the pertinent content is downloaded to the video playing device 102, the content is presented to the viewer for viewing, as indicated in block 408. Notably, this step may simply comprise playing the downloaded content. Alternatively, however, this step can further comprise first receiving the user's permission to play the content, for instance indicated by the selection of a “play” command associated with the content.

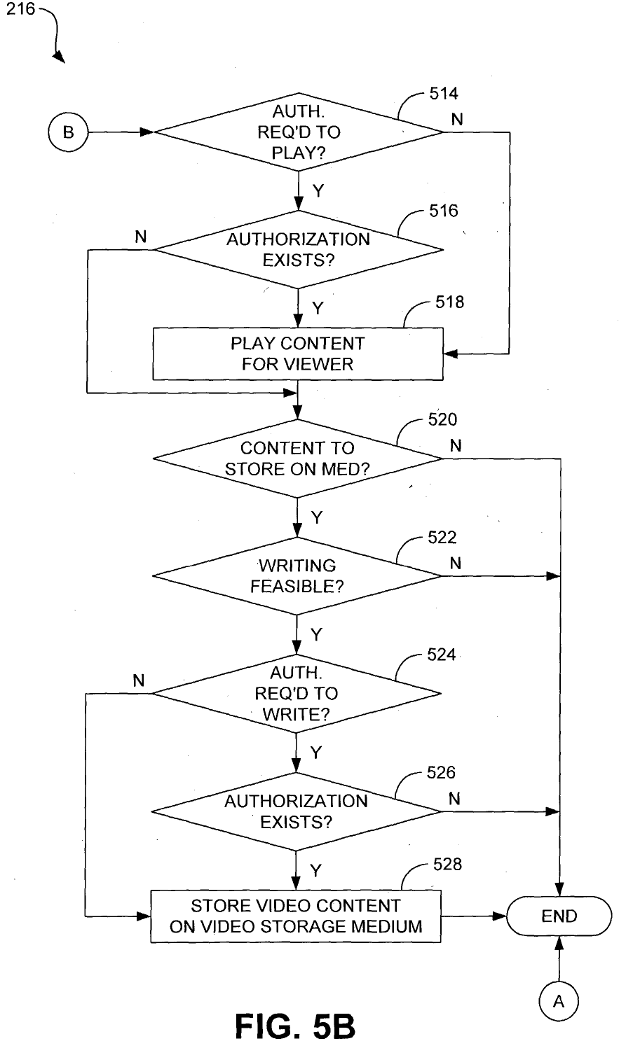

FIGS. 5A and 5B illustrate an example of operation of the content manager 216 of the video playing device 102. Beginning with block 500 of FIG. 5A, a “play” command is first received by the video playing device 102, thereby initiating the content manager 216. Once initiated, the content manager 216 reads the content source network address associated with the video storage medium 106, as indicated in block 502. As described above with reference to FIG. 4, the address may be stored within the video storage medium 106 as data, or may be otherwise readable by the video playing device 102 (i.e., by a scanner). By way of example, the network address comprises a universal resource locator (URL) that identifies the location of the content source 104 on the network 114 and, more particularly, of video content that is available for download to the video playing device 102.

Before any downloading occurs, it can be determined whether authorization is required prior to downloading content, as indicated in decision block 504. Specifically, it can be determined whether the viewer has provided authorization for downloading such content. This authorization may be indicated by one or more user settings that the viewer has previously registered with the video playing device 102. Alternatively, authorization can be obtained by prompting the user to approve downloading (e.g., by selection of an “okay” command). Notably, this authorization can, optionally, be provided (or denied) after an initial download through which the nature of the available content is first obtained to provide the viewer with a basis for making the download decision (e.g., “Extra footage is available for download.”). In any case, if no authorization is required, flow continues down to block 508 described below. However, if authorization is required, flow continues to decision block 506 at which it is determined whether such authorization exists. If not, flow for the session for the content manager 216 is terminated (FIG. 5B).

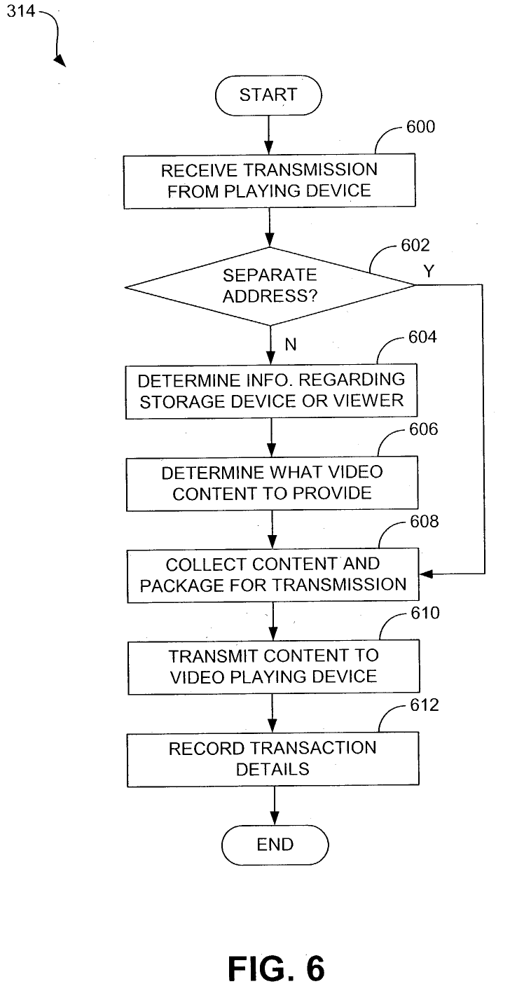

If authorization exists (or is not required), a download request is transmitted to the content source 104, as indicated in block 508. Normally, this request merely comprises a communication made by the content manager 216 to the content source 104. With reference to FIG. 6, illustrated is an example of operation of the content download manager 314 of the content source 104. As indicated in block 600 of FIG. 6, the content download manager 314 receives the transmission sent by the video playing device 102. In one embodiment, the content download manager 314 can merely be configured to download given content whenever it receives a communication from a video playing device 102. In such a case, the content source network address may be an address specifically associated with the particular video storage medium 106 that provided the address. For instance, where the video storage medium 106 stores a copy of the movie “The Godfather,” the network address may identify the location of content specifically intended to be provided for that movie. This content may include, for example, advertisements for the movies “The Godfather II” and “The Godfather III,” or for other Mafia-themed movies that are available for purchase.

In another embodiment, the content download manager 314 is configured to determine information about the particular video storage device 106 at issue or, optionally, information about the viewer to determine what content to download. In such a case, the transmission from the video playing device 102 includes information, for example provided in a header of the transmission, that identifies the particular storage medium or the viewer's identity. In keeping with the example cited above, this information could indicate that the viewer is about to watch “The Godfather” and/or that the viewer is “John Smith” (as indicated by a user code). In the latter case, information such as user preferences may have been registered by the user with the playing device 102 or a network service during a, previous registration process. Alternatively or in addition, information can be provided about other movies (or other features) that the viewer has watched (e.g., tracked by the playing device 102) that will be used to determine what video content to download.

In view of the above, whether the content source network address is an address that is separately provided for a given video storage device 106 (e.g., “The Godfather” DVD), will dictate whether content will automatically be downloaded, or whether a determination must first be made as to what content to download. Therefore, with reference to decision block 602, if the network address comprises a separate address for the particular video storage device 106, the video content to download is known (i.e., fixed) and flow continues to down to block 608 described below. Otherwise, flow continues to block 604 at which the content download manager 314 determines information about the video storage device 106 and/or viewer and, with reference to block 606, determines what video content to provide to the video playing device 102. The determination depends upon what information is collected about the video storage medium 106 and/or viewer, and may involve consulting a look up table that stores associations between given video storage media 106 or viewers and downloadable video content.

With reference to block 608, video content is collected and packaged for transmission to the video playing device 102. At this point, the content is transmitted, via the network 114, to the video playing device 102, as indicated in block 610. After the content has been successfully downloaded, the content download manager 314 can record any pertinent details regarding the transaction that occurred, as indicated in block 612. For instance, in an arrangement in which an advertiser (e.g., product manufacturer) pays the video storage medium distributor on a per-advertisement basis, the content download manager can record that the advertisement was downloaded in relation to a particular video storage medium 106 on a particular date. In a further example, the content download manager 314 can record information regarding whether a particular advertisement was actually played and, therefore, most likely viewed by the viewer. Determination of whether an advertisement was actually played can be made in several different ways. For example, the advertisement content downloaded the viewer's video playing device 102 can include an appropriate call-back device, such as a Web beacon (“Web bug”), that is activated when advertisement content is played by the video playing device 102.

In yet another example, the content download manager 314 can record what content was downloaded in relation to what viewer, for instance where the content is only downloaded in exchange for a fee. Examples of fee-based downloads include content comprising re-mastered scenes that replace original scenes of a movie, content comprising the next feature of a series (e.g., sequel movie or next episode or “chapter” of a serial feature), another similar feature (e.g., movie of the same genre), and the like. Notably, where a large amount of content will be downloaded, the viewer may be prompted/required to provide a blank storage medium (e.g., DVD) on which the content will be stored. In such a scenario, payment of the fee can be facilitated by a service which automatically adds a charge to the viewer's account. Alternatively, payment can be facilitated through communications back and forth between the viewer (via the user interface devices 204) and the content source 104. From these examples, it can be appreciated that various different types of information may be stored by the content download manager 314, much of which may facilitate billing and revenue generation. Once this information is recorded, flow for the content download manager 314 is terminated. At this point, the stored information can be used for billing purposes by an appropriate accounting program or service.

With reference back to FIG. 5A, the video playing device 102 next receives and unpacks the video content provided by the content source 104, as indicated in block 510, and, as indicated in block 512, stores the video content in memory. By way of example, the content is stored locally in device memory 202 (e.g., hard drive). Alternatively, however, the content can be stored in another location such as an external mass storage device. Next, referring to decision block 514 of FIG. 5B, the content manager 216 determines whether authorization is required to play the downloaded content. If not, flow continues to block 518 described below. If so, however, flow continues to block 516 at which it is determined whether authorization exists. By way of example, authorization can be obtained by first notifying the user to the fact that content has been downloaded (and potentially identifying its nature) and prompting the viewer to respond “yes” or “no” to a display query. If authorization is not received, flow continues to decision block 520 described below.

If authorization does exist (or if it is not required), the content is played for the viewer, as indicated in block 518. As noted above, this playing may result in a call back to the content source 104 for purposes of tracking actual viewing of the content. Assuming, the downloading occurred in the background while a copyright notice or other opening sequence was shown, the downloaded content may be played immediately for the viewer. In situations in which the downloaded content comprises part of the recorded feature (e.g., new scenes for a movie), playing of the content may not occur immediately. In such as case, playing of the content is synchronized with the playing of the recorded feature and buffering is used so that the video playing device 102 can switch back and forth between playing the original feature content and playing the downloaded content as seamlessly as possible.

Referring next to decision block 520, the content manager 216 determines whether the downloaded content is to be stored on the video storage medium 106. This option may be particularly desirable where the content comprises new and/or re-mastered scenes for a movie stored on the video storage medium 106. If the content is not be stored on the storage medium 106, flow is terminated. If, on the other hand, the content is to be stored on the medium 106, flow continues to decision block 522 at which it is determined whether writing is feasible. This determination is made with regard to whether the video playing device 102 is configured to write to the video storage medium 106 (e.g., whether the device is a read/write DVD player), whether the video storage medium is writable (e.g., where the medium is a RW DVD), whether there is adequate space left on the medium to write the new content, etc.

If writing is not feasible, flow is terminated and the content is not written to the video storage medium 102. Regardless, however, the content is stored, at least temporarily, in device memory 202. If, however, writing is feasible, it is determined whether authorization is required to store the content on the video storage medium 106, as indicated in decision block 524. If not, flow continues to block 528 described below. If so, however, flow continues to decision block 526 at which it is determined whether authorization exists. Again, authorization can be obtained by prompting the viewer for permission. If authorization does not exist, flow is terminated and the content is not stored to the video storage medium 106. If authorization is provided, however, flow continues to decision block 528 and the content is stored on (i.e., written to) the video storage medium 106. Notably, this storage takes place when the viewer is not viewing other content stored on the video storage medium 106. Therefore, storage may occur after the video playing device 102 is turned “off.” In any case, the new content will be available for viewing the next time the video storage medium 106 is played by the viewer.

As can be appreciated from the foregoing discussion, control over what content is downloaded to the video playing device 102 may be provided to the viewer. In addition to the viewer merely permitting or not permitting such downloading to occur, the viewer can, in some embodiments, control downloading so that desired content is downloaded while undesired content is not. Therefore, as indicated above in relation to block 502, authorization can, optionally, be provided after an initial download is conducted through which the nature of the available content is first obtained. In such a scenario, the viewer may select (using the user interface devices) the various content portions that are to be downloaded.

The viewer control described above can be used to obtain content such as movie extras while filtering out advertising material. Such control also permits alternative uses. For example, this control may be used to control which of several alternative endings (e.g., a happy ending versus a sad ending) is selected for a given movie, to select which of several biographies of a movie actor to download, etc. In this manner, the viewer may in effect browse various different content that is available from one or more content sources 104 to determine exactly what content he or she would like to download to the video playing device and, optionally, the storage medium 106.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for updating viewable content, comprising:
reading a network address from a video storage medium using a video playing device;
accessing a content source via a network with the video playing device using the network address;
downloading video content from the content source; and
providing the downloaded video content to a viewer.

2. The method of claim 1, wherein the step of reading a network address comprises reading an address stored on the video storage medium.

3. The method of claim 1, wherein the step of reading a network address comprises reading a code provided on a housing of the video storage medium with a scanner.

4. The method of claim 1, wherein the step of accessing a content source comprises accessing a content source using a network client of the video playing device.

5. The method of claim 1, wherein the step of downloading video content from the content source comprises one of downloading advertising content and feature content that adds to or modifies the original feature.

6. The method of claim 1, wherein the step of downloading video content from the content source comprises downloading the video content to memory of the video playing device.

7. The method of claim 1, further comprising storing the downloaded video content on the video storage medium.

8. A method for providing updated video content to a digital video disc (DVD) viewer, comprising:
reading a DVD that stores a viewable feature to determine a network address of a content source;
accessing the content source using the stored network address;
downloading video content from the content source, the video content being associated with the viewable feature stored on the DVD; and
playing the downloaded video content for a viewer.

9. The method of claim 8, wherein the step of accessing the content source comprises accessing the content source via a network using a network client of a DVD player.

10. The method of claim 9, wherein the step of downloading video content comprises downloading the video content to memory of the DVD player.

11. The method of claim 8, further comprising storing the video content on the DVD.

12. The method of claim 8, further comprising prompting the viewer for authorization to play the downloaded video content before the step of playing the downloaded video content.

13. A method for providing video content to a viewer of a video storage medium, comprising:
receiving a transmission from a video playing device;
determining one of information about a video storage medium being played by the video playing device and information about the user;
determining what video content to provide to the viewer based upon the determined information; and
transmitting selected video content to the video playing device for playing for the viewer.

14. The method of claim 13, further comprising recording details about what video content was transmitted.

15. The method of claim 14, further comprising recording details about one of the video storage medium being viewed and the viewer.

16. A program for providing updated video content to a viewer, the program stored on a computer-readable medium, the program comprising:
logic configured to initiate reading of a network address of a content source, the network address stored on a video storage-medium;
logic configured to initiate transmission of a content download request to the content source;
logic configured to receive and store video content transmitted from the content source; and
logic configured to present the stored video content to the viewer.

17. The program of claim 16, further comprising logic configured to initiate writing of the stored video content to the video storage medium.

18. A program for providing video content to a viewer, the program stored on a computer-readable medium, the program comprising:
logic configured to receive a download request from a video playing device;
logic configured to determine what video content to provide to the viewer based upon information contained in the request; and
logic configured to initiate transmission of selected video content to the video playing device.

19. The program of claim 18, wherein the logic configured to determine what video content to provide comprises logic configured to determine one of information about the video storage medium being viewed and information about the viewer.

20. The program of claim 18, further comprising logic configured to record details about what video content was transmitted.

21. The program of claim 20, further comprising logic configured to record details about one of the video storage medium being viewed and the viewer.

22. A video playing device, comprising:
a video storage medium interface device;
a processing device;
a memory comprising a content manager, the content manager comprising logic configured to initiate reading of a network address of a content source, the network address stored on a video storage medium, logic configured to initiate transmission of a content download request to the content source, and logic configured, to receive and store video content transmitted from the content source.

23. The video playing device of claim 22, wherein the video storage medium interface device comprises a medium reading head.

24. The video playing device of claim 22, wherein the logic configured to initiate transmission of a content download request comprises a network client.

25. The video playing device of claim 22, further comprising logic configured to present the stored video content to the viewer.

26. The video playing device of claim 22, further comprising logic configured to initiate writing of the stored video content to the video storage medium.

27. The video playing device of claim 22, wherein the video playing device comprises a digital video disc (DVD) player.
